(19) United States
(12) Patent Application Publication
(10) Pub. No.: US 2010/0174609 A1
(43) Pub. Date: Jul. 8, 2010

(54) METHOD AND SYSTEM FOR CORRECTING BIAS INTRODUCED BY ESTIMATING OFFER VALUES

(75) Inventors: Eric Theodore Bax, Altadena, CA (US); Julian Romero, Los Angeles, CA (US)

Correspondence Address: BRINKS HOFER GILSON & LIONE / YAHOO! OVERTURE, P.O. BOX 10395, CHICAGO, IL, 60610, US

(73) Assignee: YAHOO! Inc., Sunnyvale, CA (US)

(21) Appl. No.: 12/348,248

(22) Filed: Jan. 2, 2009

(51) Int. Cl. G06Q 40/00; G06Q 30/00

(52) U.S. Cl. 705/14.71; 705/36 R

(57) ABSTRACT

A system and method for improving online advertising auctions. The system includes an offer store configured to received offers from advertisers bidding do display advertisements to users. An estimator engine in communication with the offer store estimates values for each of the offers to produce estimated offer values. An adjustment engine in communication with the estimator engine adjusts the estimated offer values to correct for bias introduced by estimating values for the offers. An auction engine in communication with the adjustment engine selects one or more advertisements for display to a user based on the adjusted estimated offer values.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### SUMMARY

The present application provides a system and method for optimizing offer values. The system includes an offer store configured to receive a plurality of offers from advertisers bidding in auctions to display advertisements to users. An estimator engine in communication with the offer engine determines an estimated value for each of the offers. The estimated offer values are based on an estimated probability of action corresponding to each offer. The estimated probabilities of action may be calculated according to data stored in the system. The data may include any relevant information associated with user interactions with advertisements, such as the historical click through rate of a given advertisement.

The system further includes an adjustment engine in communication with the estimator engine and configured to adjust each of the estimated offer values in order to correct for bias introduced by estimating values for the offers. The adjustment engine may generate adjusted estimated offer values based on one or more factors, such as the total number of offers, the estimated offer values, and the amount of learning associated with each offer. The amount of learning can include any empirical data stored in the system that is associated with a given advertisement. Additionally, an auction engine in communication with the adjustment engine is configured to compare the adjusted estimated offer values in order to select one or more winning advertisements for display to a user. The auction engine may include an ad allocation module configured to allocate the winning advertisements into a plurality of ad slots based on the adjusted estimated offer values. The auction engine may also include an ad pricing module configured to set prices for the winning advertisements based on the adjusted estimated offer values.

Further objects, features and advantages of this system will become readily apparent to persons skilled in the art after a review of the following description, with reference to the drawings and claims that are appended to and form a part of this specification.

### BRIEF DESCRIPTION OF THE DRAWINGS

FIG. 1 is a schematic view of a system for adjusting estimated offer values;

FIG. 2 is a graph illustrating the impact on revenue resulting from adjusting estimated offer values based on standard deviations;

FIG. 3 is a graph illustrating the impact on fairness resulting from adjusting estimated offer values based on standard deviations;

FIG. 4 is a graph illustrating the impact on revenue resulting from adjusting estimated offer values based on the number of offers in each auction;

FIG. 5 is a graph illustrating the impact on fairness resulting from adjusting estimated offer values based on the number of offers in each auction;

FIG. 6 is a flowchart illustrating a method of adjusting estimated offer values; and

FIG. 7 is a schematic view of a computer system for implementing the methods described.

### DETAILED DESCRIPTION

With the advent of the Internet, Internet-based advertising has become increasingly popular among advertisers for promoting their products and services. Advertisements may comprise banner ads, links to web pages, images, video, text, etc. The various advertisements used to promote products on the Internet may be displayed according to a variety of formats, such as in conjunction with a ranked result set in response to a query, embedded in a web page, a pop-up, etc.

Client devices, communicatively coupled to a network such as the Internet, are capable of accessing various websites that may display advertisements. For example, a user of a client device may submit a search request comprising one or more terms to a search engine, which causes the search engine to retrieve a result set comprising links to content, as well as advertisements responsive to the search terms provided by a user. The search engine generates and displays a result set to a user who may then select or view items in the result set, including one or more advertisements. Revenue for the search engine provider is typically generated from the advertisements that are displayed to users in response to search requests.

As used herein, Internet publishers supported by advertising may include e-mail providers, content providers, search engine providers, etc. Internet publishers may charge advertisers for displaying advertisements based on various pricing models. Brand advertisers (i.e., advertisers that show advertisements to build brand awareness), for example, generally prefer paying by the impression, known as cost per impression (CPM) pricing. Other advertisers, called performance advertisers, show advertisements to have users complete a desired action (e.g., clicking on an ad to see a landing page designated by the advertiser, offering the advertisers contact information by filling out a form on a landing page, or making a purchase). Performance advertisers generally prefer paying by the action, which is generally known as cost per action (CPA) pricing. Cost per click (CPC) pricing is a popular type of CPA pricing.

Generally, an exchange manages an auction for impressions offered by a publisher, in which brand advertisers and performance advertisers can compete for the same impressions based on expected revenue, called expected cost per mine (eCPM), or thousand impressions. For CPM pricing, eCPM is simply equal to the advertisers bid for the impression. For CPA pricing, eCPM is equal to the advertisers bid for an action multiplied by the probability that the action will result from awarding the impression to the advertiser, called probability of action. Since the probability of action is not known exactly, however, the eCPM for performance advertisers is estimated based on an estimated probability of action. For instance, one common technique for estimating probabilities of action is based on historical click through data of advertisements. Historical click through data indicates the frequency with which one or more advertisements were selected when displayed.

If an auction has multiple advertisements from performance advertisers and multiple advertisements from brand advertisers, the auction can be seen as selecting a maximum estimated eCPM among the performance advertisements and comparing it to a maximum exact eCPM among brand advertisements. Even if the estimated eCPMs are unbiased, however, taking the maximum among estimates introduces bias. As a result, the expected maximum among estimated eCPMs becomes greater than the expected maximum among actual eCPMs for the performance advertisers.

One drawback associated with estimating eCPMs is that the bias introduced by maximizing estimated eCPMs impacts fairness and revenue. In general, advertisers with less accurate eCPM estimates gain an unfair advantage over advertisers with more accurate eCPM estimates. In other words, performance advertisers obtain an unfair advantage over brand advertisers. Additionally, since performance advertisers pay based on actual actions rather than estimated actions, the publishers and exchange suffer a loss of revenue.

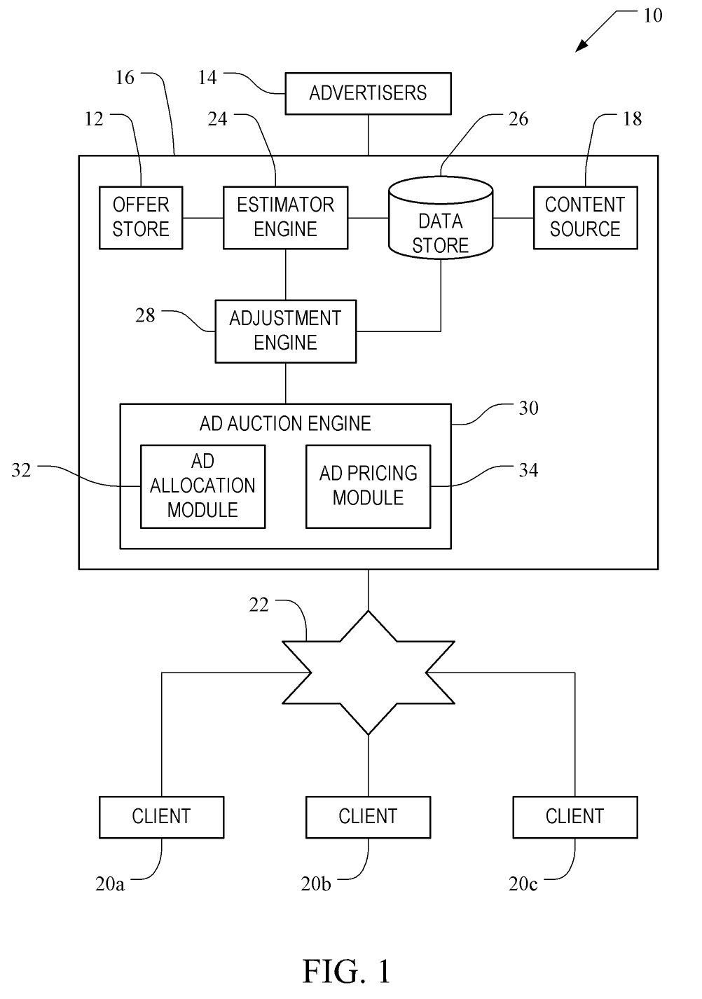

Referring now to FIG. 1, a system embodying the principles of the present application is illustrated therein and designated at 10. The system 10 includes an offer store 12 configured to receive a plurality of offers from advertisers 14 bidding in auctions to display advertisements on web pages. The offer store 12 may be operated by a publisher 16 maintaining a website (not shown). The website may comprise one or more content sources 18 configured to receive and process requests conducted by users via client devices 20a, 20b, and 20c. The client devices 20a, 20b, and 20c are communicatively coupled to a network 22, which may include a connection to one or more local and/or wide area networks, such as the Internet.

In an alternative embodiment, the offer store 12 may be operated by an intermediary such as, but not limited to, an exchange (not shown) configured to host an auction for impressions offered by the publisher 16. As used herein, an impression refers to each opportunity to display an advertisement to a user. The advertisements may comprise, but are not limited to, banner advertisements, websites, links, images, video, text, etc.

The offers corresponding to the advertisements can be based on various pricing models known in the art. For instance, an advertiser may agree to pay each time the advertisement is displayed, as in cost per impression (CPM) pricing. Alternatively, an advertiser may agree to pay each time the advertisement is clicked or selected by a user 16, as in cost per click (CPC) pricing, or similarly, each time a specified action associated with the advertisement occurs, as in cost per action (CPA) pricing. As used herein, it should be understood that the term “action” can be any desired result specified by an advertiser, including, but not limited to, a click, purchase, download, registration, etc.

Upon receiving the offers from the advertisers 14, the offer store 12 determines which advertisements are eligible for display. Eligibility of an advertisement is generally based on selection criteria specified by the advertisers 14 and/or publisher 16. Selection criteria can be based on any number of factors, including, but not limited to, size of the advertisement, type of advertisement, targeted users, geography, frequency cap, budget, format, content, expected revenue, etc.

The system 10 further comprises an estimator engine 24 in communication with the offer store 12. The estimator engine 24 is configured to calculate an estimated offer value for each advertisement based on an expected revenue per impression (eCPM). The eCPM is calculated based on an estimated probability of action, i.e., the probability that an action specified by the advertiser 14 will occur for a given advertisement impression. For CPM pricing, eCPM is simply equal to the advertisers 14 bid for the impression. For CPC and CPA pricing, eCPM is equal to the advertisers 14 bid for a specified action multiplied by the probability of that action occurring. Since the probability of action is not known exactly for CPC and CPA pricing, the estimator engine 24 estimates the probability of action. For instance, for CPC pricing, the estimator engine 24 estimates the probability that a user will click on the advertisers 14 advertisement.

In determining the eCPM for each of the offers, the estimator engine 24 takes into account a variety of factors, such as, but not limited to, advertisement information stored in the system 10. The system 10 may include various techniques known to those skilled in the art for storing information. In one embodiment, for example, the system 10 includes a data store 26 in communication with the estimator engine 16 and the one or more content sources 18. The data store 26 may comprise one or more accessible memory structures such as a database, CD-ROM, tape, digital storage library, etc. Advertisement information stored in the data store 26 may be maintained in groups according to various factors, such as, but not limited to, advertiser, product, category, search requests, etc. Additionally, advertisement information stored in the data store 26 may be maintained according to advertiser specified groups, such as for a given advertisement campaign.

The data store 26 is configured to maintain any relevant information associated with user interactions with advertisements and may be implemented as a database or any type of data storage structure capable of providing for the retrieval and storage of a variety of data types. For instance, the data store 26 may maintain historical information associated with advertisements, such as the frequency a given advertisement was displayed to a user in response to a search request, the frequency a desired action resulted when a given advertisement was displayed to a user in response to a search request, the number of impressions a given advertisement was shown on, information pertaining to users viewing a given advertisement (e.g., age, gender, location, etc.), the amount of revenue generated from a given advertisement, etc. Additionally, the data store 26 is periodically populated with data indicating user interactions with one or more advertisements, including one or more search requests that resulted in the display of an advertisement.

According to one embodiment, the estimator engine 24 is configured to utilize the information stored in the data store 26 in order to determine an estimated probability of action for each of the advertisements. The estimator engine 24 may determine the estimated probabilities of action based on various machine learning models known in the art, and/or any prediction method known in the art, including, but not limited to, Bernoulli sampling. For instance, the estimator engine 24 may first calculate an estimated probability of action for each advertisement based on information stored in the data store 26. Alternatively, if little or no information associated with a given advertisement is known, the estimator engine 24 may use any known information associated with related advertisements. Related advertisements may be determined according to any similarity or relatedness techniques known to those of skill in the art. In addition, the estimator engine 24 may be configured to periodically update the estimated offer values in order to account for new information accumulated in the data store 26.

The system further includes an adjustment engine 28 and an auction engine 30. The adjustment engine 28 is in communication with the estimator engine 24 and the data store 26 and is configured to adjust each of the estimated offer values to produce adjusted estimated offer values in order to correct for bias introduced by estimating values for the offers. The auction engine 30 is in communication with the adjustment engine 28 and is configured to select a set of advertisements for display to a user based on the adjusted estimated offer values. As used herein, a set of advertisements may include one or more advertisements.

In one embodiment, the adjustment engine adjusts each of the estimated offer values by subtracting a penalty d from each estimated offer value to produce adjusted estimated offer values, as illustrated by the following equation:

\hat{p}=p(1−d),

where:
\hat{p} represents the adjusted estimated offer value for each of the advertisements;
ρ represents the estimated offer value (i.e., the estimated probability of action) for each of the advertisements; and
d represents a reduction factor configured to optimize revenue, fairness, or a combination thereof.

Alternatively, the adjustment engine 28 may use different penalties d for CPC offers and CPA offers in order to optimize revenue and/or fairness. Optimal penalties d can be determined according to various statistical optimization techniques known to those skilled in the art. For instance, d may be calculated using a gradient descent algorithm. To illustrate the impact on revenue and fairness caused by using different penalties, the examples in Tables 1-4 are provided below.

TABLE 1

| | CPA | | | | | | | | | | |
|---|---|---|---|---|---|---|---|---|---|---|---|
| | penalties d | 0 | 0.1 | 0.2 | 0.3 | 0.4 | 0.5 | 0.6 | 0.7 | 0.8 | 0.9 |
| CPC | 0 | 16.4 | 12.6 | 9.1 | 7.0 | 6.4 | 6.4 | 6.4 | 6.4 | 6.4 | 6.4 |
| | 0.1 | 17.7 | 13.7 | 9.2 | 6.0 | 4.9 | 4.8 | 4.8 | 4.8 | 4.8 | 4.8 |
| | 0.2 | 18.3 | 14.5 | 10.2 | 7.1 | 5.9 | 5.9 | 5.9 | 5.9 | 5.9 | 5.9 |
| | 0.3 | 18.4 | 14.8 | 10.6 | 7.6 | 6.5 | 6.5 | 6.6 | 6.6 | 6.6 | 6.6 |
| | 0.4 | 18.5 | 14.8 | 10.6 | 7.6 | 6.6 | 6.6 | 6.6 | 6.6 | 6.6 | 6.6 |
| | 0.5 | 18.4 | 14.8 | 10.6 | 7.6 | 6.6 | 6.6 | 6.6 | 6.6 | 6.6 | 6.6 |
| | 0.6 | 18.4 | 14.8 | 10.6 | 7.6 | 6.6 | 6.6 | 6.6 | 6.6 | 6.6 | 6.6 |
| | 0.7 | 18.5 | 14.8 | 10.6 | 7.6 | 6.6 | 6.6 | 6.6 | 6.6 | 6.6 | 6.6 |
| | 0.8 | 18.5 | 14.8 | 10.6 | 7.6 | 6.6 | 6.6 | 6.6 | 6.6 | 6.6 | 6.6 |
| | 0.9 | 18.4 | 14.8 | 10.6 | 7.6 | 6.6 | 6.6 | 6.6 | 6.6 | 6.6 | 6.6 |

Table 1 illustrates the impact on revenue from using separate penalties d for CPC and CPA offers, where the impact on revenue is measured as a percent of ideal revenue lost by using adjusted estimated offer values. As used herein, ideal revenue is the expected revenue if winning offers were selected based on actual or true probabilities of action rather than based on estimated probabilities of action.

In Table 1, each entry represents the average revenue impact, expressed a percentage, over one million simulated auctions. For each auction, five CPM offers, five CPC offers, and five CPA offers are randomly generated. Actual values for offers are drawn independently from a normal distribution with a mean equal to $1.00 and a standard deviation equal to $0.10. For CPM offers, the actual probability of action is equal to 1.0. For CPC offers, the actual probability of action is equal to 0.01. For CPA offers, the actual probability of action is equal to 0.001. The estimated offer values ρ are determined based on 10,000 simulated learning auctions. Looking at Table 1, it can be seen that the revenue-optimizing penalties for CPA offers range from 0.5 to 0.9.

TABLE 2

| | CPA | | | | | | | | | | |
|---|---|---|---|---|---|---|---|---|---|---|---|
| | penalties d | 0 | 0.1 | 0.2 | 0.3 | 0.4 | 0.5 | 0.6 | 0.7 | 0.8 | 0.9 |
| CPC | 0 | 21.3 | 27.5 | 34.1 | 38.2 | 39.6 | 39.2 | 39.1 | 39.3 | 39.2 | 39.2 |
| | 0.1 | 20.2 | 27.2 | 35.3 | 41.2 | 43.0 | 42.7 | 42.5 | 42.6 | 42.6 | 42.5 |
| | 0.2 | 18.8 | 24.6 | 31.1 | 35.8 | 36.9 | 36.3 | 36.1 | 36.2 | 36.2 | 36.1 |
| | 0.3 | 18.4 | 23.8 | 29.7 | 33.7 | 34.4 | 33.8 | 33.6 | 33.6 | 33.5 | 33.5 |
| | 0.4 | 18.4 | 23.7 | 29.7 | 33.7 | 34.2 | 33.6 | 33.4 | 33.3 | 33.4 | 33.4 |
| | 0.5 | 18.4 | 23.7 | 29.7 | 33.7 | 34.2 | 33.5 | 33.3 | 33.3 | 33.3 | 33.4 |
| | 0.6 | 18.4 | 23.8 | 29.7 | 33.7 | 34.2 | 33.5 | 33.4 | 33.4 | 33.3 | 33.4 |
| | 0.7 | 18.4 | 23.8 | 29.7 | 33.7 | 34.1 | 33.7 | 33.4 | 33.3 | 33.3 | 33.3 |
| | 0.8 | 18.4 | 23.8 | 29.6 | 33.6 | 34.2 | 33.6 | 33.3 | 33.4 | 33.4 | 33.3 |
| | 0.9 | 18.5 | 23.8 | 29.7 | 33.7 | 34.2 | 33.6 | 33.4 | 33.4 | 33.3 | 33.3 |

Table 2 illustrates the impact on fairness from using separate penalties d for CPC and CPA offers. Each entry in Table 2 shows the fraction of auctions won by the ideal winner for the simulated auctions for each corresponding entry in Table 1. By comparing Tables 1 and 2, it can be seen that the penalties d which maximize revenue are nearly the same as those which maximize fairness.

Tables 3 and 4 below illustrate the impact on revenue and fairness, respectively, based on simulations similar to those used to generate the data for Tables 1 and 2, except that 100,000 simulated learning auctions are used for each CPA offer, and 10,000 simulated learning auctions are used for each CPC offer. Thus, it can be seen that the added learning decreases the revenue- and fairness-optimizing adjustments for CPA offers, and it makes the optimal adjustment the same for CPC and CPA offers.

TABLE 3

CPA

| | penalties d | 0 | 0.1 | 0.2 | 0.3 | 0.4 |
|---|---|---|---|---|---|---|
| CPC | 0 | 5.7 | 5.5 | 6.2 | 6.4 | 6.4 |
| | 0.1 | 5.5 | 3.8 | 4.4 | 4.8 | 4.8 |
| | 0.2 | 6.2 | 4.4 | 5.3 | 5.9 | 5.9 |
| | 0.3 | 6.4 | 4.8 | 5.9 | 6.5 | 6.6 |
| | 0.4 | 6.4 | 4.8 | 5.9 | 6.6 | 6.6 |

TABLE 4

CPA

| | penalties d | 0 | 0.1 | 0.2 | 0.3 | 0.4 |
|---|---|---|---|---|---|---|
| CPC | 0 | 42.3 | 43.8 | 40.2 | 39.2 | 39.2 |
| | 0.1 | 43.6 | 49.3 | 44.6 | 42.7 | 42.5 |
| | 0.2 | 40.1 | 44.6 | 38.8 | 36.3 | 36.1 |
| | 0.3 | 39.1 | 42.7 | 36.3 | 33.8 | 33.6 |
| | 0.4 | 39.1 | 42.6 | 36.1 | 33.6 | 33.4 |

In yet another embodiment of this application, the adjustment engine 28 may apply various machine learning models to adjust the estimated offer values. For instance, any machine learning model known to those of skill in the art may be used to generate one or more functions to adjust the estimated offer values. The one or more functions can include numerous inputs such as, but not limited to, the number of offers, the estimated offer values, and the amount of learning associated with each of the offers. The amount of learning can include any empirical data stored in the data store 26 that is associated with a given advertisement. For instance, by collecting empirical data over time, the machine learning model can create a distribution of a priori estimated probabilities of action compared to actual posterior frequencies of action, to form empirical priors. Accordingly, the adjustment engine 28 may apply a machine learning model based on Bayesian principles, for example, using the empirical priors to generate the one or more functions to adjust the estimated offer values. Furthermore, simulations may be conducted to select starting points for the parameters, and any statistical optimization technique known to those skilled in the art may be used to adjust the parameters to optimize revenue, fairness, or any combination thereof.

In one aspect of this embodiment, the adjustment engine 28 generates the adjusted estimated offer values by subtracting a multiple of an estimated standard deviation of the difference between the estimated probability of action associated with each offer and the actual probability of action associated with each offer. For instance, the adjustment engine 28 may calculate the adjusted estimated offer values according to the following equation:

$$\hat{p} = p - c \sqrt{\frac{p ( 1 - p )}{n}} ,$$

where:
\hat{p} is the adjusted estimated offer value for each of the advertisements;
ρ is the estimated offer value (i.e., the estimated probability of action) for each of the advertisements;
n is a number of auctions used to determine the estimated offer value for each of the offers; and
c is an adjustment coefficient selected to optimize revenue, fairness, or a combination thereof. Optimal values of c can be calculating using various optimizing techniques known in the art, such as, but not limited to, gradient descent algorithms.

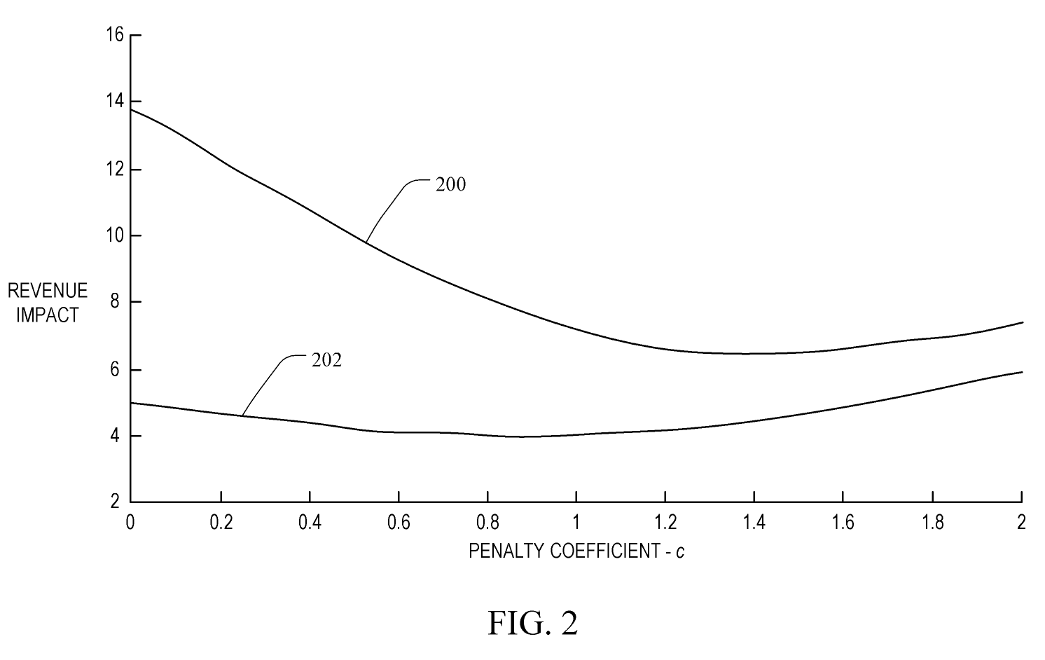

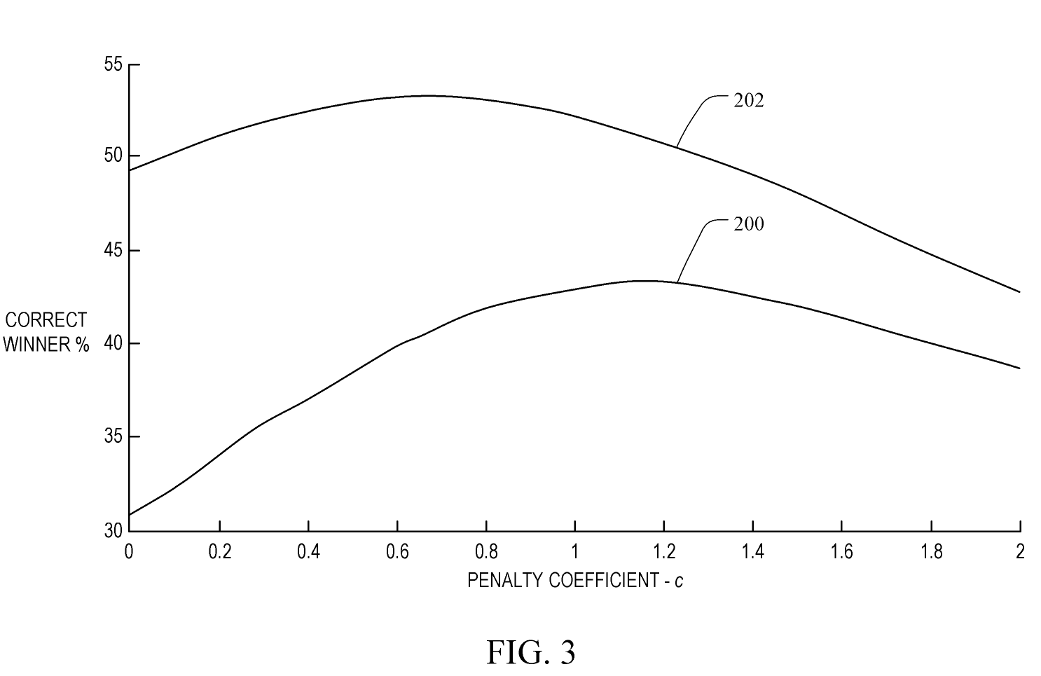

FIGS. 2 and 3 illustrate the impact on revenue and fairness based on examples of adjusting estimated offer values based on standard deviation. The graphs in FIGS. 2 and 3 are based on two types of auctions, one in which there are are low amounts of learning associated with the CPA offers, and one in which there are high amounts of learning associated with the CPA offers. In FIGS. 2 and 3, Line 200 represents the impact based on the simulated auctions with low amounts of learning, and Line 202 represents the impact based on the simulated auctions with high amounts of learning. In the auctions with low amounts of CPA learning, estimated offer values ρ are drawn based on a Bernoulli distribution that simulates learning with 10,000 auctions, for both CPC and CPA offers. In the auctions with high amounts of CPA learning, 10,000 auctions are simulated for CPC offers, and 1 00,000 auctions are simulated for CPA offers.

In both types of auctions, each plotted value in FIGS. 2 and 3 is based on the same 100,000 simulated auctions, using a different adjustment coefficient c. Each auction has ten randomly generated offers, where each offer is selected from a uniform distribution over CPM, CPC, and CPA offer types. For CPM offers, the actual probability of action is equal to 1.0. For CPC offers, the actual probability of action is equal to 0.01. For CPA offers, the actual probability of action is equal to 0.001. Actual values for the offers are drawn uniformly at random from a normal distribution with a mean equal to $1.00 and a standard deviation equal to $0.10.

FIG. 2 illustrates the average over the 100,000 simulated auctions of revenue impact as a percentage, wherein revenue impact is the fraction of ideal revenue lost due to using estimated probabilities. FIG. 3 illustrates the impact on fairness, wherein fairness is measured as the percentage of auctions won by the ideal winner (i.e., the offer with the greatest expected return). In the auctions with low amounts of CPA learning, it can be seen that using a revenue-maximizing coefficient c equal to 1.4 increases revenue by over 7%. In the auctions with high amounts of CPA learning, it can be seen that using a revenue-maximizing coefficient c equal to 0.8 increases revenue by about 1%. Additionally, by comparing FIGS. 2 and 3, it can be seen that revenue-maximizing values of c are close to fairness-maximizing values of c, and vice-versa.

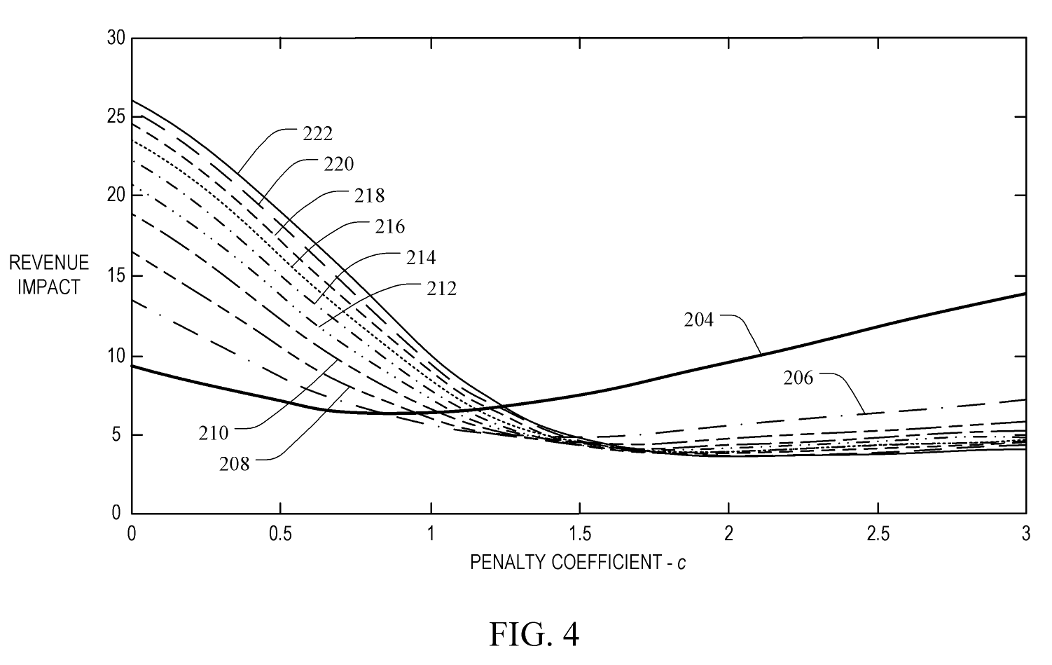

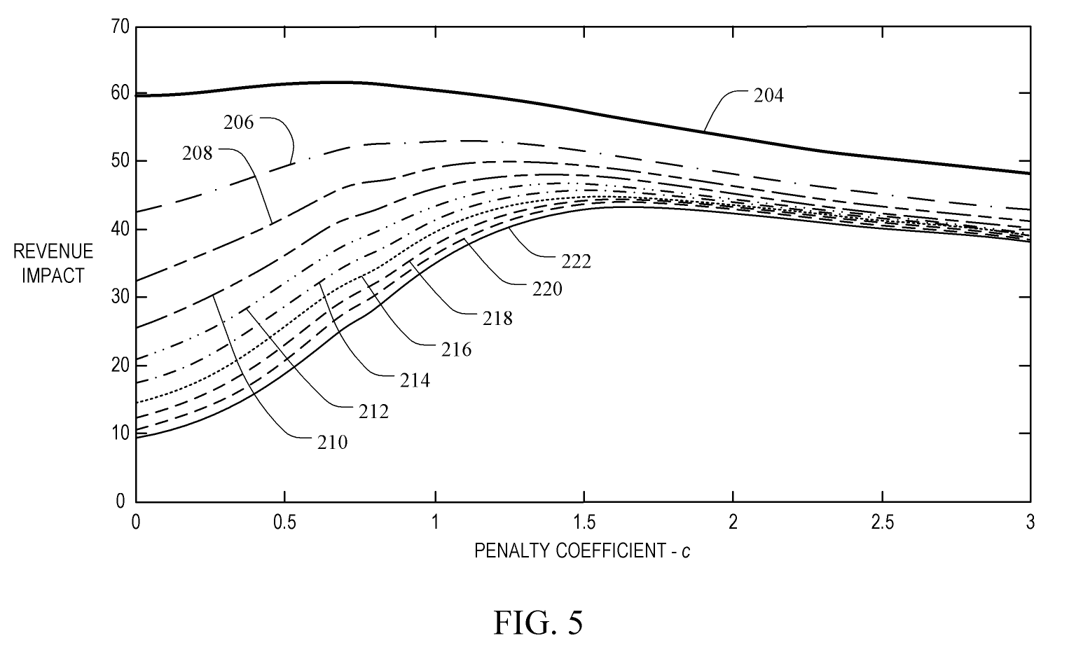

FIGS. 4 and 5 illustrate how the total number of offers in each auction impact revenue and fairness based on standard deviations. The graphs in FIGS. 4 and 5 are based on the same simulations. In FIGS. 4 and 5, Lines 204, 206, 208, 210, 212, 214, 216, 218, 220, and 222 represent the impact on revenue and fairness based on auctions with 4 offers, 8 offers, 12 offers, 16 offers, 20 offers, 24 offers, 28 offers, 32 offers, 36 offers, and 40 offers, respectively. For each number of offers (4, 8, . . . , 40), the data for all values of c are based on the same one million auctions, and for each auction, the specified number of offers are generated independently at random. The offers may include CPM offers, CPC offers, and/or CPA offers. For CPM offers, the actual probability of action is equal to 1.0. For CPC offers, the actual probability of action is drawn uniformly at random from {0.005, 0.01, 0.02, 0.05}. For CPA offers, the actual probability of action is drawn uniformly at random from {0.0002, 0.0005, 0.001, 0.002}. For all offer types, the number of simulated learning auctions n is drawn uniformly at random from {5000, 10,000, 50,000, 100,000}. The estimated probability of action p is determined by drawing from a Bernoulli distribution based on actual probability of action and the number of simulated auctions n. Actual values are drawn at random from a Gaussian with mean equal to $1.00 and standard deviation equal to $0.10, and bids are set by dividing actual values by probabilities of action.

TABLE 5

| | Revenue | Optimal | | Correct | Optimal | |
|---|---|---|---|---|---|---|
| | Impact % | Revenue | Revenue | Winner % | Correct | Fairness |
| Offers | (c = 0) | Impact % | Optimizing c | (c = 0) | Winner % | Optimizing c |
| 4 | 9.3 | 6.4 | 0.9 | 59.6 | 61.7 | 0.7 |
| 8 | 13.4 | 4.9 | 1.4 | 42.3 | 53.1 | 1.1 |
| 12 | 16.5 | 4.5 | 1.6 | 32.3 | 49.7 | 1.3 |
| 16 | 18.9 | 4.2 | 1.7 | 25.4 | 47.8 | 1.4 |
| 20 | 20.8 | 4.0 | 1.8 | 20.5 | 46.6 | 1.5 |
| 24 | 22.3 | 3.9 | 1.9 | 16.9 | 45.6 | 1.5 |
| 28 | 23.6 | 3.8 | 1.9 | 14.2 | 44.8 | 1.6 |
| 32 | 24.6 | 3.8 | 2.0 | 12.0 | 44.3 | 1.6 |
| 36 | 25.4 | 3.7 | 2.0 | 10.4 | 43.9 | 1.6 |
| 40 | 26.1 | 3.6 | 2.0 | 9.1 | 43.3 | 1.7 |

Table 5 summarizes the results from FIGS. 4 and 5. For each auction size, there are columns on revenue impact and fairness. The revenue impact columns show revenue impact without an adjustment, optimal revenue impact, and the revenue-optimizing value of the adjustment coefficient. Differences between revenue impact without adjustment and with the optimal adjustment indicate the potential to increase revenue by adjusting estimated probabilities. Similarly, the fairness columns show fairness without an adjustment, optimal fairness, and the fairness-optimizing adjustment. The differences between fairness without adjustment and fairness with the optimal adjustment indicate the potential to increase fairness.

In yet another embodiment of the present application, the auction engine 30 may include an ad allocation module 32 configured to allocate the one or more winning advertisements into a plurality of ad spots based on the adjusted estimated offer values. The auction engine 30 may also include an ad pricing module 34 configured to set a price for the one or more winning advertisements based on the adjusted estimated offer values. In one aspect of this embodiment, the ad allocation module 32 and the ad pricing module 34 may assign ad slots and set prices based on adjusted estimated offer values calculated using different adjustment coefficients. The adjusted estimated offer values may be calculated according to the equation

$$\hat{p} = p - c \sqrt{\frac{p ( 1 - p )}{n}} ,$$

where:
\hat{p} is the adjusted estimated offer value for each of the advertisements;
ρ is the estimated offer value (i.e., the estimated probability of action) for each of the advertisements;
n is a number of auctions used to determine the estimated offer value for each of the offers; and
coefficient c is a variable selected to optimize revenue, fairness, or a combination thereof. Optimal values of c may be selected using any statistical optimization technique known to those of skill in the art, such as, but not limited to, gradient descent algorithms.

Thus, given k ad slots, different values of c (e.g., c=c₁ . . . cₖ) are used for different ad slots. For instance, the adjustment engine 28 first adjusts the estimated offer values for all of the offers using c₁. Next, the ad allocation module 32 ranks the adjusted estimated offer values according to any specified preference, e.g., expected revenue, and awards the first (or most desirable) ad slot to the highest ranked offer (breaking ties randomly). In turn, the ad pricing module 34 sets a price for the winning offer based on the second highest ranked offer, or according to any desired pricing model known to those of skill in the art. This process repeats using c₂ for the second ad slot, c₃ for the third ad slot, and continues accordingly.

Alternatively, the ad allocation module 32 and the ad pricing module 34 may assign ad slots and set prices based on adjusted estimated offer values calculated using the same adjustment coefficient c for each ad slot. For instance, if little or no empirical data is available for a given advertisement, it may be desirable to calculate the adjusted estimated offer values according to the equation

$$\hat{p} = p - c \sqrt{\frac{p ( 1 - p )}{n}} ,$$

where coefficient c is a constant selected to optimize revenue, fairness, or a combination thereof. An optimal value of c may be selected using any statistical optimization technique known to those of skill in the art, such as, but not limited to, gradient descent algorithms.

Table 6 below compares the impact on revenue based on examples using a uniform adjustment for each ad slot and examples using different adjustments for each ad slot.

TABLE 6

8 Number of Offers

| | 6 | 10 | 15 | 20 | 25 | 30 |
|---|---|---|---|---|---|---|
| \hat{R}ₛ | 3.59 | 3.86 | 4.32 | 4.57 | 4.81 | 4.95 |
| \hat{R}_{d} | 3.22 | 3.72 | 4.23 | 4.54 | 4.77 | 4.91 |
| \hat{R}ₛ − \hat{R}_{d} | 0.37 | 0.14 | 0.11 | 0.03 | 0.04 | 0.04 |

In Table 6, revenue impact using different adjustment coefficients for each ad slot is calculated as follows:

$${\hat{R}}_{d} = \frac{{r}^{*} - {\hat{r}}_{d}}{{r}^{*}}$$

and revenue impact using the same adjustment coefficient for each ad slot is calculated as follows:

$${\hat{R}}_{s} = \frac{{r}^{*} - {\hat{r}}_{s}}{{r}^{*}}$$

To further describe the results in Table 6, the following definitions are provided:
r* is the ideal revenue (i.e., the expected revenue if winning offers were selected based on actual or true probabilities of action rather than based on estimated probabilities of action);
\hat{r}_{d} is the expected revenue based on the adjusted estimated offer values calculated using different adjustment coefficients; and
\hat{r}ₛ is the expected revenue based on the adjusted estimated offer values calculated using a constant adjustment coefficient.

The results in Table 6 are based on a set of 10,000 simulated auctions. Each offer is generated independently. The actual values for each offer are determined by a Gaussian with mean equal to $1.00 and standard deviation equal to $0.10. The actual probability of action for each offer is selected at random from {0.005, 0.01, 0.015, . . . , 0.05}. The estimated probability of action for each offer is drawn randomly based on a Bernoulli distribution simulating n learning auctions, where n is selected uniformly at random from {1000, . . . , 10,000}. Looking at the bottom row in Table 6, it can be seen that using different adjustment coefficients is more advantageous when there are fewer offers. When there are many offers, on the other hand, the optimal adjustment coefficients for different slots are closer to each other, so using different coefficients is less advantageous.

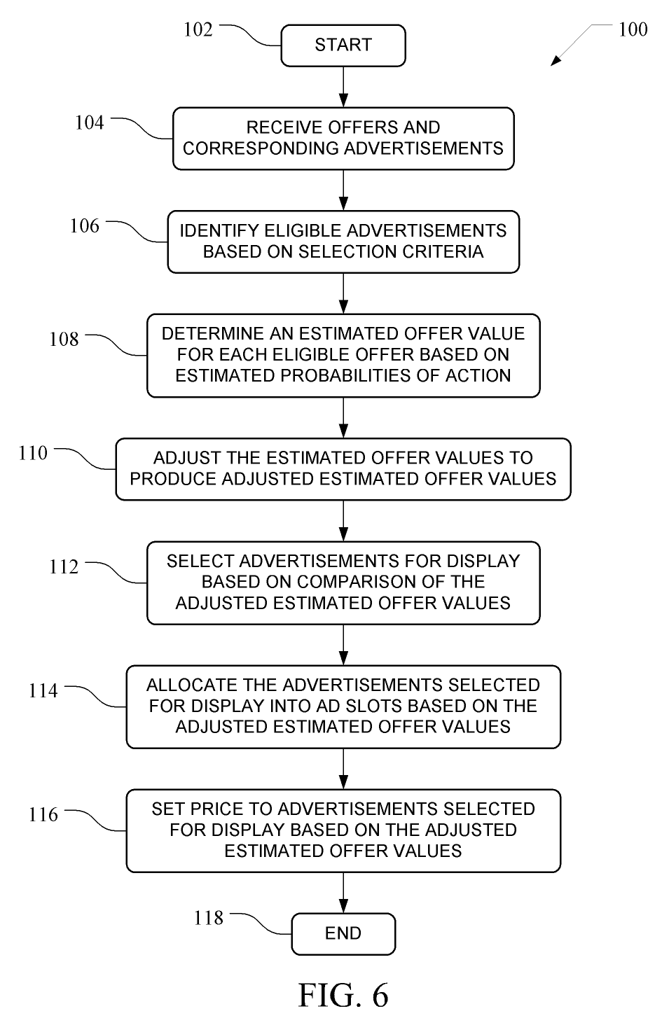

Referring now to FIG. 6, a method 100 for correcting bias introduced by estimating values of a plurality of offers in an auction starts in block 102. A set of advertisements associated with the offers are received as noted in block 104. In block 106, advertisements that are eligible for display to a user are identified. Eligibility may be based on selection criteria specified by advertisers and/or publishers. In block 108, an estimated offer value is calculated for each of the eligible advertisement offers. The estimated offer values are based on expected revenues associated with each advertisement, wherein the expected revenues are determined according to estimated probabilities of action. The method may implement various machine learning algorithms and/or predictions models to estimate probabilities of action.

In block 110, the estimated offer values are adjusted to produce adjusted estimated offer values in order to correct for bias introduced by determining estimated values for the offers. The adjusted estimated offer values may be based on the number of eligible advertisement offers, the estimated offer values, the amount of learning associated with each advertisement offer, or any combination thereof. The method may implement any now known or later discovered learning models to produce the adjusted estimated offer values.

Continuing with block 112, a set of advertisements is selected for display to a user, wherein the set of advertisements is selected based on a comparison of the adjusted estimated offer values. The set of advertisements selected for display may be allocated into a plurality of ad slots based on the adjusted estimated offer values, as denoted by block 114. Additionally, the set of advertisements selected for display may be assigned a price based on the adjusted estimated offer values, as denoted by block 116. The method ends in block 118.

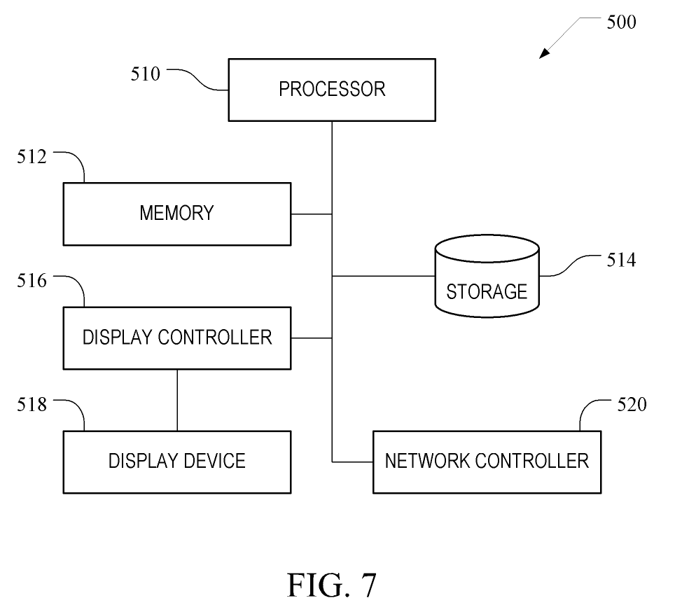

Any of the modules, servers, or engines described may be implemented in one or more general computer systems. One exemplary system is provided in FIG. 7. The computer system 500 includes a processor 510 for executing instructions such as those described in the methods discussed above. The instructions may be stored in a computer readable medium such as memory 512 or a storage device 514, for example a disk drive, CD, or DVD. The computer may include a display controller 516 responsive to instructions to generate a textual or graphical display on a display device 518, for example a computer monitor. In addition, the processor 510 may communicate with a network controller 520 to communicate data or instructions to other systems, for example other general computer systems. The network controller 520 may communicate over Ethernet or other known protocols to distribute processing or provide remote access to information over a variety of network topologies, including local area networks, wide area networks, the Internet, or other commonly used network topologies.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

Further the methods described herein may be embodied in a computer-readable medium. The term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

As a person skilled in the art will readily appreciate, the above description is meant as an illustration of the principles of this invention. This description is not intended to limit the scope or application of this invention in that the invention is susceptible to modification, variation and change, without departing from the spirit of this invention, as defined in the following claims. For example, the techniques outlined above may be applied to any types of sales where one or more offer values are estimated, e.g., sales where some buyers have a risk of under-payment or non-payment due to bankruptcy or failure to obtain credit, sales where one or more offers have a probability of under-delivery or non-delivery, etc. Accordingly, those of skill in the art will understand that the techniques may be applied to any type of sale involving risks, such as, but not limited to, sales where there are risks regarding production, risks of crop failure, or transportation risks.

We claim:

1. A system for correcting bias introduced by estimating values of a plurality of offers in an auction, the system comprising:
an offer store configured to receive the plurality of offers, wherein each offer of the plurality of offers is associated with at least one advertisement;
an estimator engine in communication with the offer store and configured to generate an estimated value for each offer of the plurality of the offers to produce estimated offer values, wherein the estimated offer values are based on an estimated probability of action associated with each offer;
an adjustment engine in communication with the estimator engine and configured to adjust the estimated offer values to produce adjusted estimated offer values, wherein the adjusted estimated offer values are corrected for bias introduced by generating the estimated offer values; and
an auction engine in communication with the adjustment engine and configured to select a set of advertisements of the at least one advertisement for display to a user, wherein the set of advertisements selected for display are selected based on a comparison between the adjusted estimated offer values.

2. The system of claim 1, further comprising a data store in communication with the estimator engine and configured to store data associated with the at least one advertisement, wherein the estimator engine utilizes the data to generate the estimated offer values.

3. The system of claim 1, wherein the adjusted estimated offer values are adjusted via the adjustment based on a total number of offers comprising the plurality of offers.

4. The system of claim 1, wherein the adjusted estimated offer values are adjusted via the adjustment engine based on the estimated offer values.

5. The system of claim 1, wherein the adjusted estimated offer values are adjusted based on an amount of data associated with each offer of the plurality of offers.

6. The system of claim 1, wherein the adjusted estimated offer values are adjusted via the adjustment engine according to at least one function having at lest one input, the at least one input being configured to optimize fairness, revenue, or a combination thereof.

7. The system of claim 6, wherein the at least one function is calculated through the use of machine learning.

8. The system of claim 7, wherein the use of machine learning utilizes empirical data from past auctions.

9. The system of claim 6, wherein the at least one input comprises an input selected from a group consisting of: a total number of offers comprising the plurality of offers, the estimated offer values, and an amount of data associated with each offer of the plurality of offers.

10. The system of claim 1, wherein the auction engine comprises:
an ad allocation module configured to allocate the set of advertisements selected for display into ad spots based on the adjusted estimated offer values; and
an ad pricing module configured to price the set of advertisements selected for display based on the adjusted estimated offer values.

11. The system of claim 1, wherein the adjusted estimated offer values are proportional to the estimated offer values.

12. The system of claim 11, wherein the estimated offer values are adjusted by subtracting a reduction factor from the estimated offer values to produce the adjusted estimated offer values; and
wherein the reduction factor is a variable selected to optimize auction revenue, fairness, or a combination thereof.

13. A system for correcting bias introduced by estimating values of a plurality of offers in an auction, the system comprising:
an offer store configured to receive the plurality of offers, wherein each offer of the plurality of offers is associated with at least one advertisement;
an estimator engine in communication with the offer store and configured to generate an estimated value for each offer of the plurality of the offers to produce estimated offer values, wherein the estimated offer values are based on an estimated probability of action associated with each offer;
an adjustment engine in communication with the estimator engine and configured to adjust the estimated offer values to produce adjusted estimated offer values, wherein the adjusted estimated offer values are corrected for bias introduced by generating the estimated offer values; and
an auction engine in communication with the adjustment engine and configured to select a set of advertisements of the at least one advertisement for display to a user, wherein the set of advertisements selected for display are selected based on a comparison between the adjusted estimated offer values;
wherein the estimated offer values are adjusted via the adjustment engine based on an estimated standard deviation between the estimated probability of action associated with each offer of the plurality of offers and an actual probability of action associated with each offer of the plurality of offers.

14. The system of claim 13, wherein the estimated offer values are adjusted via the adjustment engine by subtracting a multiple of the estimated standard deviation from the estimated offer values to produce the adjusted estimated offer values.

15. The system of claim 13, wherein the adjustment engine is configured to adjust the estimated offer values based on a relationship
$$\hat{p} = p - c \sqrt{\frac{p ( 1 - p )}{n}} ,$$
where:
\hat{p} is the adjusted estimated offer value for each offer of the plurality of offers;
ρ is the estimated offer value for each offer of the plurality of offers;
n is a number of auctions used to determine the estimated offer value p for each offer of the plurality of offers; and
c is a coefficient selected to optimize auction revenue, fairness, or a combination thereof.

16. The system of claim 2, wherein the data associated with the one or more advertisements comprises action history, impression history, or a combination thereof.

17. A method for correcting bias introduced by estimating values of a plurality of offers in an auction, the method comprising the steps of:
receiving the plurality of offers, wherein each offer of the plurality of offers is associated with at least one advertisement;
determining an estimated value for each offer of the plurality of offers to produce estimated offer values, wherein the estimated offer values are determined according to an estimated probability of action associated with each of the at least one advertisement;
adjusting the estimated offer values to produce adjusted estimated offer values, wherein the adjusted estimated offer values are corrected for bias introduced by determining the estimated offer values; and
comparing the adjusted estimated offer values in order to select a set of advertisements of the at least one advertisement for display to a user.

18. The method of claim 17, wherein the adjusted estimated offer values are adjusted based on a factor selected from a group consisting of: a total number of offers comprising the plurality of offers, the estimated offer values, and an amount of data associated with each offer of the plurality of offers.

19. The method of claim 17, wherein the adjusted estimated offer values are adjusted according to at least one function having at least one input, the at least one input being configured to optimize fairness, revenue, or a combination thereof;
wherein the at least one function is calculated through the use of machine learning; and
wherein the use of machine learning utilizes empirical data from past auctions.

20. The method of claim 19, wherein the at least one input comprises an input selected from a group consisting of: a total number of offers comprising the plurality of offers, the estimated offer values, and an amount of data associated with each offer of the plurality of offers.

21. The method of claim 17, further comprising:
allocating the set of advertisements selected for display into ad slots based on the adjusted estimated offer values; and
pricing the set of advertisements selected for display based on the adjusted estimated offer values.

22. The method of claim 17, wherein the estimated offer values are adjusted by subtracting a reduction factor from the estimated offer values to produce the adjusted estimated offer values; and
wherein the reduction factor is a variable selected to optimize auction revenue, fairness, or a combination thereof.

23. The method of claim 17, wherein the adjusted estimated offer values are adjusted based on an estimated standard deviation between the estimated probability of action associated with each offer of the plurality of offers and an actual probability of action associated with each offer of the plurality of offers; and
wherein the adjusted estimated offer values are adjusted by subtracting a multiple of the estimated standard deviation from the estimated offer values to produce the adjusted estimated offer values.

24. In a computer readable storage medium having stored therein instructions executable by a programmed processor for correcting bias introduced by estimating values of a plurality of offers in a transaction, the storage medium comprising instructions for:
receiving the plurality of offers, wherein each offer of the plurality of offers is associated with at least one advertisement;
determining an estimated value for each offer of the plurality of offers to produce estimated offer values, wherein the estimated offer values are determined according to an estimated probability of action associated with each of the at least one advertisement;
adjusting the estimated offer values to produce adjusted estimated offer values, wherein the adjusted estimated offer values are corrected for bias introduced by determining the estimated offer values; and
comparing the adjusted estimated offer values in order to select a set of advertisements of the at least one advertisement for display to a user.

25. The computer readable storage medium of claim 24, wherein the adjusted estimated offer values are adjusted based on a factor selected from a group consisting of: a total number of offers comprising the plurality of offers, the estimated offer values, and an amount of data associated with each offer of the plurality of offers.

26. The computer readable storage medium of claim 24, wherein the adjusted estimated offer values are adjusted according to at least one function having at least one input, the at least one input being configured to optimize fairness, revenue, or a combination thereof;
wherein the at least one function is calculated through the use of machine learning; and
wherein the use of machine learning utilizes empirical data from past auctions.

27. The computer readable storage medium of claim 26, wherein the at least one input comprises an input selected from a group consisting of: a total number of offers comprising the plurality of offers, the estimated offer values, and an amount of data associated with each offer of the plurality of offers.

28. The computer readable storage medium of claim 24, wherein the estimated offer values are adjusted by subtracting a reduction factor from the estimated offer values to produce the adjusted estimated offer values; and
wherein the reduction factor is a variable selected to optimize auction revenue, fairness, or a combination thereof.

29. The computer readable storage medium of claim 24, further comprising:
allocating the set of advertisements selected for display into ad slots based on the adjusted estimated offer values; and
pricing the set of advertisements selected for display based on the adjusted estimated offer values.

30. The computer readable storage medium of claim 24, wherein the adjusted estimated offer values are adjusted based on an estimated standard deviation between the estimated probability of action associated with each offer of the plurality of offers and an actual probability of action associated with each offer of the plurality of offers; and
wherein the adjusted estimated offer values are adjusted by subtracting a multiple of the estimated standard deviation from the estimated offer values to produce the adjusted estimated offer values.
